(19) United States
(12) Patent Application Publication
(10) Pub. No.: US 2013/0202126 A1
(43) Pub. Date: Aug. 8, 2013

(54) HEADPHONES ACTIVATED BY ROTATION OF AN EAR CUP

(71) Applicants: Jinsaun Chen, New Taipei City (TW); Kent Lee, New Taipei City (TW); Tzu Chun Liang, New Taipei City (TW)

(72) Inventors: Jinsaun Chen, New Taipei City (TW); Kent Lee, New Taipei City (TW); Tzu Chun Liang, New Taipei City (TW)

(21) Appl. No.: 13/368,837

(22) Filed: Feb. 8, 2012

(51) Int. Cl. H04R 1/10

(52) U.S. Cl. 381/74

(57) ABSTRACT

Headphones having an ear cup rotatable from a first rest position to a second on position which functions to automatically activate a switch assembly to connect to a power source provided in the headphones. When the ear cup is moved from the first position to the second position, a movable post moves to operate a tactile switch provided in a circuit containing the power source. When the ear cup is moved from the second position to the first position, the circuit including the power source is open and the headphones no longer operate, thereby prolonging the life of the power source. A spring is associated with the ear cup to automatically return that ear cup to the first position when the headphones are removed from the head of a user.

### BACKGROUND OF THE INVENTION

1. Field of the Invention

The present invention is directed to the field of headphones, particularly headphones which wirelessly communicate with an audio transmission device and include an on/off switch which turns on and off when the earphones of the headphones are rotated.

2. Description of the Related Art

Headphones are generally defined as a pair of earphones typically joined by a headband placed over the head for listening to audio signals, such as music or speech. Historically, headphones were connected to an audio source by a cord and as such were powered by the audio sources. The wired connection between the electrical or electronic equipment generating an audio signal and the headphones would provide a conduit for the transmission of both the electrical signals which would be transformed into an audio signal to be played by a loudspeaker included in the earphones or ear cups of the headphones, as well as to provide power for the headphones. More recently, wirelessly connected headphones have become popular. The utilization of wireless connectivity between the electronic device and headphones necessitated the use of a power source located generally on the headphone to power the headphone. The power source is generally a battery or batteries which powers the headphones once activated by an on/off switch. The on/off switch is provided at a particular location on the headphones and must be manually turned off and on. When in use, an individual will turn on the switch and place the earphones over their ears to listen to an audio transmission. When the individual is finished listen the headphones are removed from the individual's head and turned off in order to avoid draining the battery. However, quite often the individual fails to turn off the headphones when finished listening to the audio transmission and the battery is drained. As such, the next time the headphones are used new batteries must be installed.

### SUMMARY OF THE INVENTION

It is, therefore, an object of the present invention to provide headphones including a switch assembly which automatically turns off the headphones and connects to an internal battery when the headphones are in use and disconnects the battery when the headphones are not in use.

It is a further object of the present invention to provide a pair of headphones which automatically completes a circuit including the internal battery, a receiver provided in one of the ear cups and loudspeakers included in each of the ear cups when at least one of the ear cups of the headphones are rotated in one direction and automatically disconnects the internal battery from the circuit when at least one of the ear cups are rotated in the second direction opposite from the first direction.

These and other objects of the present invention will become apparent from the detailed description which follows.

A pair of headphones is provided with two ear cups connected to one another via a headband. When used to receive wireless signals, one of the ear cups is provided with an internal receiver. The receiver is wired to a loudspeaker provided in the same ear cup as the receiver, as well as a loudspeaker provided in the second ear cup. A connection between the receiver and the loudspeaker in the second ear cup is generally provided by a wire running between the receiver in the first ear cup and the loudspeaker in the second ear cup through the headband. A power source, such as one or more batteries, is provided in one of the ear cups and is used to power the receiver and the loudspeakers. The power source used to power the pair of headphones would be provided in a storage compartment which would be removed when the battery life has run low and replaced by a new battery or set of batteries. Alternatively, the battery or batteries provided in the storage compartment provided in the ear cups could be rechargeable.

When not in use, one or both of the ear cups is in a non-use first position. When an individual wishes to utilize the headphones, at least one of the ear cups is rotated to a second use position allowing an individual to put the headphones on their head, with one of the ear cups in proximity to one of the individual's ear and the other ear cup in proximity to the individual's other ear.

An on/off switch is provided on one of the ear cups and is electrically connected to the battery or batteries provided within the headphones. When the ear cups are rotated from the first, non-use position, to the second, use position, one of the ear cups is provided with a device for engaging the switch, allowing the switch to be turned on, thereby completing a circuit between the receiver and the loudspeakers, resulting in the headphones being powered by the battery or batteries. When the headphones are removed from individual's head, the switch is disconnected and the circuit, including the battery, receiver and the loudspeakers is broken, thereby preventing the unnecessary loss of life of the battery when the headphones are not in use. The disengagement of the switch would occur when at least one of the ear cups is rotated from the second use position to the first non-use position. It is noted that the present invention operates by automatically returning the ear cup provided with the switch to the first non-use position when the headphones are removed from the individual's head. This is accomplished by providing a spring associated with this ear cup. The spring becomes biased toward the first non-use position when the ear cup is rotated. Therefore, when the headphones are removed from the head of the individual, that ear cup will automatically move from the second use position to the first non-use position due to the bias of the spring, resulting in the automatic disengagement of the switch.

Since the movement of the ear cup not provided with the switch does not affect the turning on or turning off of the headphones, this ear cup can always remain in the second use position or manually move to the first non-use position without jeopardizing the life of the internal battery. Alternatively, this ear cup can also automatically rotate between the first non-use position to the second use position and vice versa under the bias of a spring.

Automatically returning the ear cup with the switch from the second use position to the first non-use position is accomplished by including the spring in the headband close to that ear cup, allowing the ear cup to return to the first non-use position when the headphones are removed from the individual's head.

Other objects and advantages of the present invention will become apparent from the following detailed description when viewed in conjunction with the accompanying drawings, which set forth certain embodiments of the invention.

### BRIEF DESCRIPTION OF THE DRAWINGS

FIG. 1 is a plan view of the headphones in accordance with the present invention.

FIG. 2 is a side view of the headphones in accordance with the present invention.

FIGS. 3A and 3B show the ear cups of the headphones in a first non-use position and then rotated to a second use position placed on a user's head, respectively.

FIG. 4 shows the switch assembly in FIG. 5 blown up.

FIG. 5 shows a side view of one ear cup of the present invention with the housing removed so that the switch assembly may be viewed.

FIGS. 6A, 6B and 6C show the operation of the switch assembly of the present invention as one of the ear cups of the headphone is rotated from its off state (FIG. 6A), to an intermediate position (FIG. 6B), to its on state (FIG. 6C).

FIGS. 7A, 7B and 7C show the operation of the switch assembly of the present invention as the ear cup is manually rotated to the on state and automatically rotated to its off state.

FIG. 8 shows a circuit diagram used to connect and disconnect the battery from the audio circuit.

### DESCRIPTION OF THE PREFERRED EMBODIMENTS

The detailed embodiment of the present invention is disclosed herein. It should be understood, however, that the disclosed embodiment is merely exemplary of the invention, which may be embodied in various forms. Therefore, the details disclosed herein are not to be interpreted as limiting, but merely as a basis for teaching one skilled in the art how to make and/or use the invention.

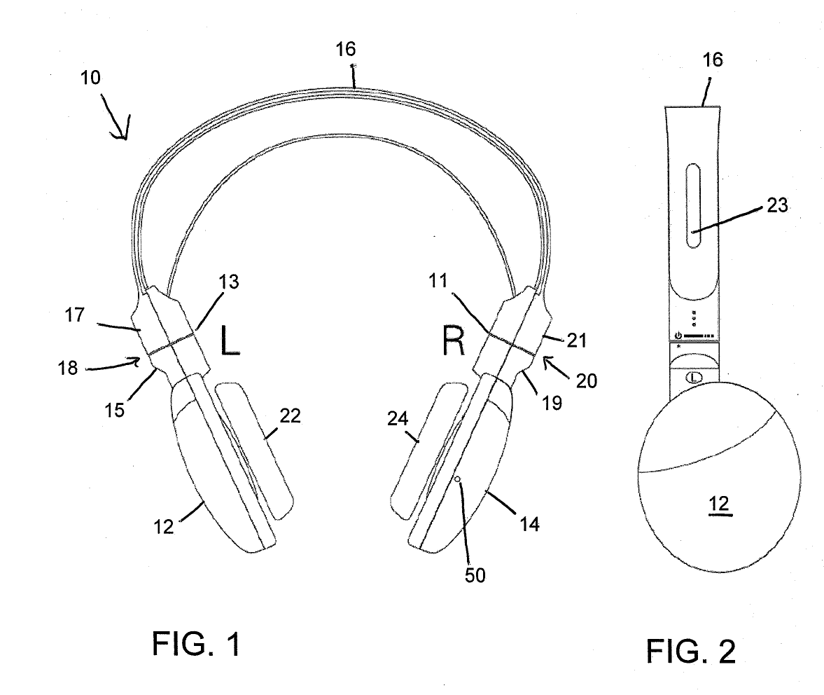

In accordance with the present invention, and with reference to FIGS. 1 to 8, the headphones 10 will be described. Headphones 10 include a Left ear cup 12 in which a loudspeaker is provided and a Right ear cup 14 in which a loudspeaker is provided. The Left and Right ear cups 12, 14 are connected via a headband 16. Ear cup 12 includes an ear pad 22 which would be in contact with a user's 70 left ear when the headphones 10 are placed upon the individual's head and ear cup 14 includes an ear pad 24 which would be in contact with a user's 70 right ear when the headphones 10 are placed upon the individual's head.

One of the ear cups 12, 14 would include a receiver for wirelessly receiving an audio transmission signal. The receiver functions to transmit the electrical signal to the loudspeakers provided in the ear cups 12, 14. The loudspeakers convert the electrical signals into an audio signal to be heard by the individual when transmitted through the ear pads 22, 24 to the ears of the user 70.

Headband 16 is provided with a rotating coupling mechanism 18 on its left side and a rotating coupling mechanism 20 on its right side which rotatably connect ears cups 12, 14 to the headband 16. The left side coupling mechanism 18 includes an upper stationary section 17 connected to or integrally formed with headband 16 and lower rotating section 15 connected to or integrally formed with ear cup 12. The right side coupling mechanism 20 includes an upper stationary section 21 connected to or integrally formed with headband 16 and lower section 19 connected to or integrally formed with ear cup 14. Section 15 rotates in conjunction with ear cup 12 and section 17 remains immobile when the ear cup 12 rotates at interface 13. Similarly, section 19 may rotate in conjunction with ear cup 14 and section 21 remains immobile when the ear cup 14 rotates at interface 11. It is also contemplated that ear cup 14 may not rotate as such sections 19 and 21 of coupling mechanism may not rotate relative to one another.

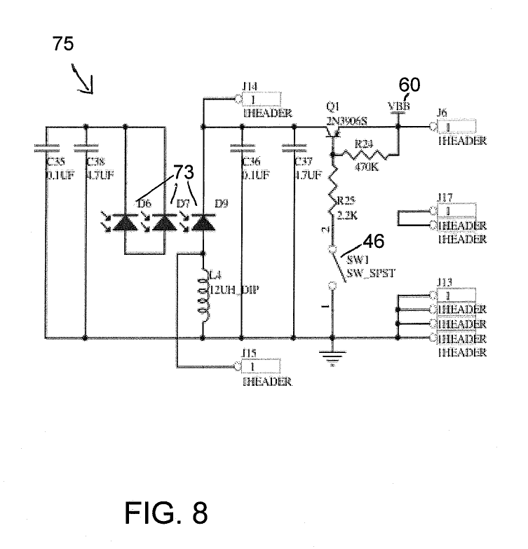

A circuit as shown in FIG. 8 would transmit the electrical signal from the receiver provided either in ear cup 12 or 14 to the loudspeaker provided in that ear cup, as well as the loudspeaker included in the other ear cup. As can be appreciated, the headband 16 can be provided with a device 23 for changing the length of the headband 16 to accommodate the head size of different individuals when the headphones are properly placed in proximity to the ears of the user 70.

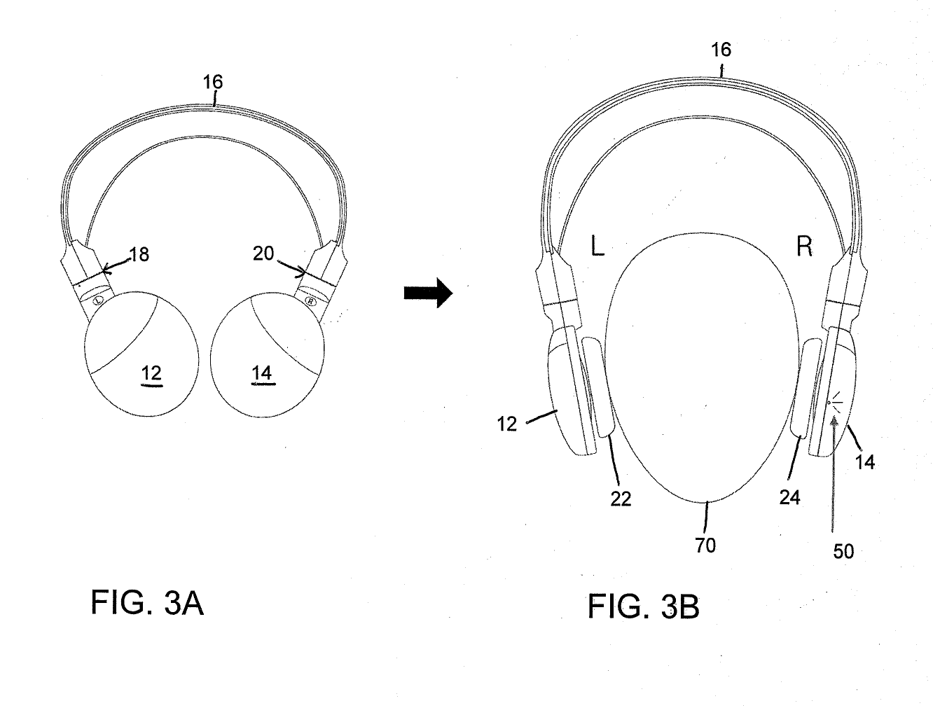

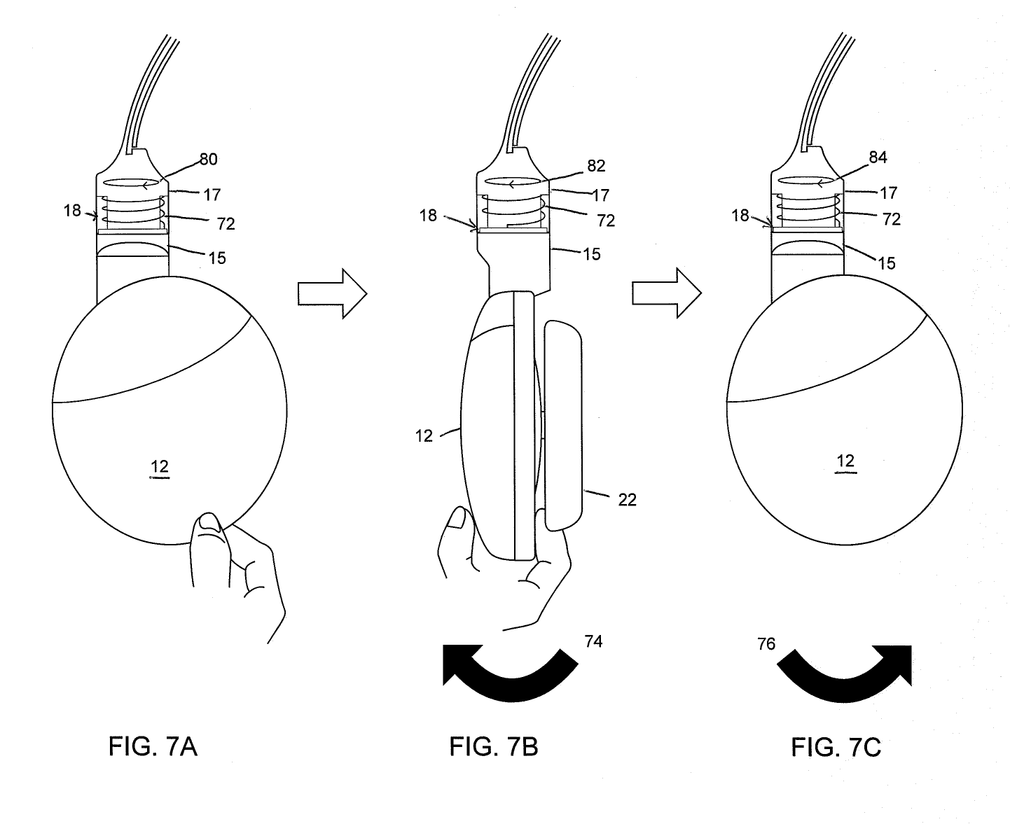

Each of the ear cups 12, 14 rotate from a first non-use position (see FIGS. 3A and 7A) to a second use position (see FIGS. 3B and 7B). As illustrated in FIG. 1, ear cup 12 will rotate at interface 13 with respect to the coupling mechanism 18 and ear cup 14 will rotate at interface 11 with respect to the coupling mechanism 20. It is noted that each of the ear cups 12, 14 can rotate independently of one another and that one or both of the coupling mechanisms will include a switch assembly 40 as described below with regard to coupling mechanism 18.

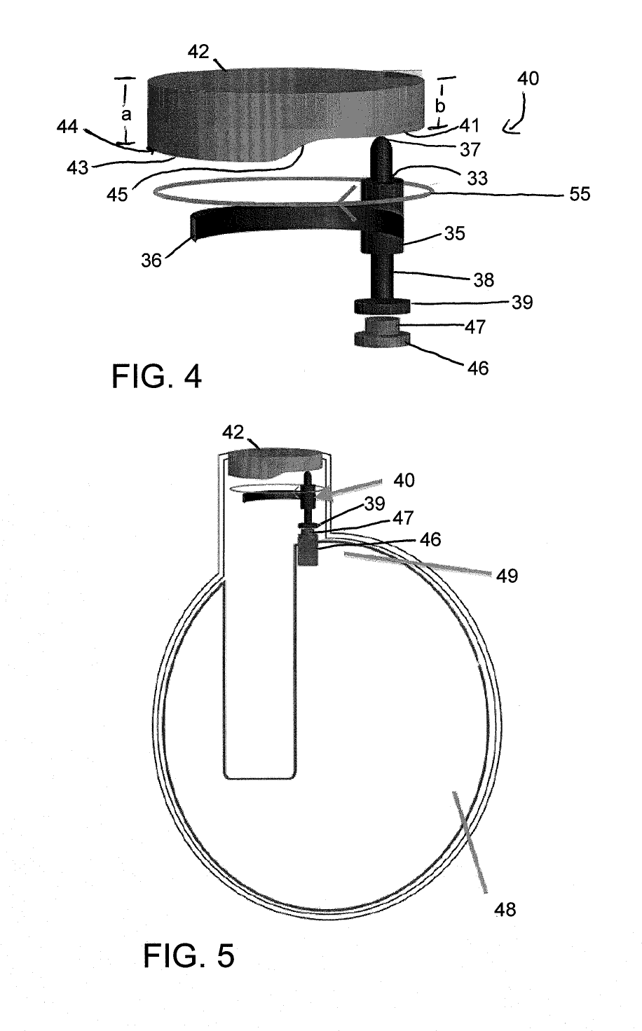

FIGS. 4 through 8 illustrate various components of the switch assembly 40 and electrical circuit utilized to engage and disengage the power source 60 including one or more batteries when the ear cups 12, 14 are rotated between the first and second positions. Although as described, only ear cup 12 automatically returns to the first non-use position when the headphones are removed from the individual's head, ear cup 14 would move manually between the first and second position or could include a spring to also move automatically between the second and first positions. The power source 60 is included in the interior of one of the ear cups 12, 14 on a printed circuit board (PCB) 48 as illustrated in FIG. 8. FIG. 4 shows various components of the interior of one of the ear cups 12, 14. It is noted that the switch assembly 40 is provided in only one of the ear cups and as shown is provided in ear cup 12. The switch assembly 40 includes a fixed cam piece 42 located in upper stationary section 17 of the left side coupling mechanism 18. The fixed cam piece 42 transitioning from a first section 41 to a second section 43 which is thicker than first section 41 to form a bottom camming surface 44 having a transition area 45. A vertical post 38 including a curved top surface 37 which travels along the bottom camming surface 44 from first section 41 to second section 43 while traversing transition area 45, as ear cup 12 is rotated from its first non-use position to its second use position as indicated by arrow 55. As such, vertical post 38 moves up and down as it travels along bottom camming surface 44. Vertical post 38 is held in position within lower rotating section 15 of coupling mechanism 18 by arm 36 having hollow cylindrical body 35 at one end thereof. Arm 36 is secured within lower rotating section 15 so as to rotate therewith. As such, vertical post 38 slides within bore 33 of hollow cylindrical body 35 as lower rotating section 15 of ear cup 12 is rotated. The bottom of the vertical post 38 is provided with a contact 39 which functions to make contact a contact 47 located on top of tactile switch 46 and thus completes the circuit connecting the power source 60 to the headphones 10 as shown in FIG. 8.

When ear cup 12 is rotated pressure is applied to the curved top surface 37 of vertical post 38 as curved top surface 37 moves along bottoming camming surface 44 from first section 41 to second section 43. The vertical post 38 moves downwardly through bore 33 of the hollow cylindrical body 35. When the vertical post 38 moves downward a predetermined distance, which is the difference between the thickness “a” of section second 43 and thickness “b” of first section 41, contact 39 makes contact with contact 47 of tactile switch 46 to turn the headphones on. When the vertical post 38 moves upward through the bore 33 of hollow cylindrical body 35, contact 39 moves away from the tactile switch 46 and the circuit with the battery would be open, thereby removing power from the headphone circuit and preserves the life of the battery when the headphones are not in use. A spring (not shown) connected to vertical post 38 is provided within the hollow cylindrical body 35 to bias the vertical post 38 upward into contact with bottom camming surface 44. The spring would push back the vertical post 38 when the ear cup is automatically returned to the first non-use position. Due to this upward bias once the post moves into transition area 45 contact 39 is no longer in contact with contact 47 of tactile switch 46.

The tactile switch 46 is provided on a portion 49 of a printed circuit board 48, allowing the switch 46 to be included in the circuitry with the power source 60 and the receiver. The PCB 48 is provided on the same ear cup that the switch assembly 40 is located.

FIG. 8 illustrates a circuit 75 provided on the PCB 48. The circuit shows the switch 46 in the open position. When contact is made between the contacts 39, 47 shown in FIG. 4, switch 46 closes and the battery or batteries which constitute the power source 60, become energized and is used to operate in infrared sensors 73 which act as the audio inputs to the headphones 10. When the contacts 39, 47 separate from one another as ear cup 12 automatically moves from the second use position to the first non-use position, the switch 46 moves to the open position.

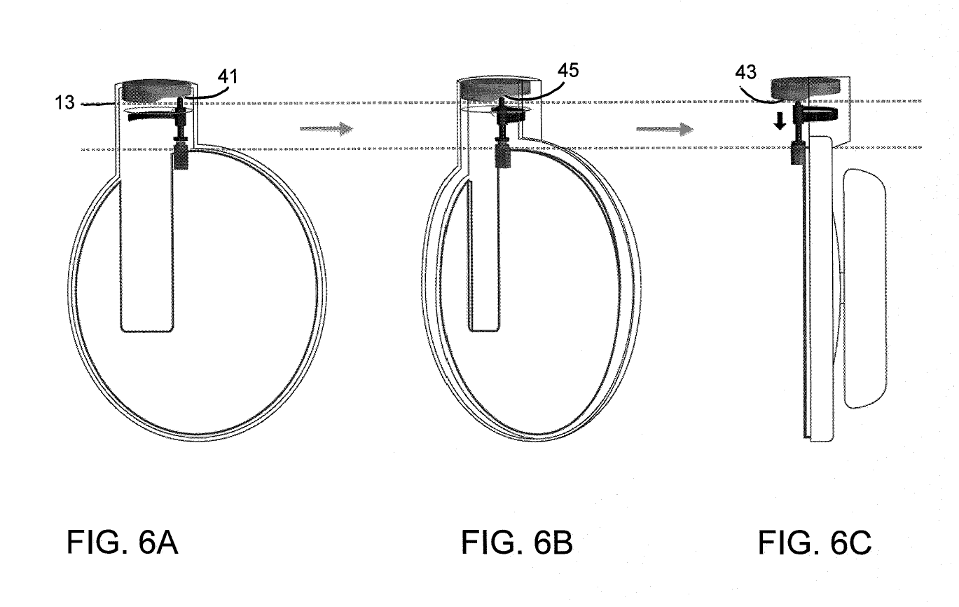

FIGS. 6A-6C show the movement of one of the ear cups from the first non-use position shown in FIG. 6A to the second use position shown in FIG. 6C. Additionally, FIG. 3A illustrates the headphones with the ear cups 12, 14 in the first non-use position. FIG. 3B illustrates the headphones with the ear cups 12, 14 in the second use position with the power source 60 connected via switch assembly 40 and the headphones powered on as indicated by 50. A visual indication that the headphones are operating can be included on the surface of one of the ear cups 12, 14. This visual indication could be a light-emitting diode (LED) or similar device.

When ear cup 12 is in the first non-use position shown in FIG. 6A, the vertical post 38 is provided under the first section 41, that is, the thinner portion of the fixed cam piece 42. It is important to note that when the ear cups 12, 14 rotate between the first and second positions, the fixed cam piece 42 is immobile. As the ear cup 12 is rotating from the first position to the second position as shown in FIG. 6B, the vertical post 38 moves into the transition area 45 of bottom camming surface 44 and contact 39 begins to move downward. Once ear cup 12 is fully rotated to the second use position as shown in FIG. 6C vertical post 38 moves under thicker second section 43 and contact 39 of vertical post 38 is moved down into contact with contact 47 of tactile switch 46, thus completing the circuit shown in FIG. 8 and powering on the headphones 10.

Since the tactile switch 46 is in direct contact with a portion 49 of the PCB 48, when the contact 39 comes in contact with contact 47 of the tactile switch 46, the circuit between the power source 60 and the receiver and the loudspeakers provided in the headphones 10 becomes activated. When the ear cup 12 is rotated from the second use position illustrated in FIG. 3B to the first non-use position shown in FIG. 3A, the contact 39 would no longer be in contact with contact 47 of tactile switch 46 as the vertical post 38 resides under thinner portion 41, thereby disconnecting the circuit and turning the headphones off. This particular configuration would then prolong the life of the power source/batteries 60 since the user 70 need not remember to turn off the circuit when the headphones are no longer being utilized.

FIGS. 7A-7C illustrate the manner in which ear cup 12 moves between the first non-use position shown in FIG. 7A to the second use position illustrated in FIG. 7B and then automatically returning to the first non-use position shown in FIG. 7C. A spring 72 acting as a return device is provided in the coupling mechanism 18 spanning the upper stationary section 17 and the lower rotating section 15. A first end of the spring 72 is fixedly connected to the upper stationary section 17. The second end of the spring 72 is fixedly connected to the lower rotating section 15. When ear cup 12 is in the first non-use position, there is no tension on the spring 72 as represented by arrow 80. When the ear cup 12 is manually moved to the second use position, tension would be applied to the spring 72 as shown by arrow 82 and is biased in the direction to automatically return the ear cup 12 to the first non-use position. When the ear cup 12 is removed from the head of an individual, it will automatically return to the first non-use position and there would be no tension on the spring 72 as shown by arrow 84. The spring 72 is biased in the direction to automatically return the ear cup 12 from the second use position to the first non-use position when the headphones 10 including the ear cup 12 is removed from the head 70 of the user.

When the user 70 wishes to utilize the headphones 10, the user 70 would manually rotate the ear cup 12 from the first non-use position illustrated in FIG. 7A to the second use position shown in FIG. 7B in direction shown by arrow 74. It is noted that a spring can or cannot be included in the coupling mechanism 20 (see FIG. 1). Therefore, ear cup 14 would move between the first non-use position and the second use position and then return to the first non-use position by manually moving the ear cup 14 if no spring is provided and automatically moving ear cup 14 to the first non-use position if a spring is included. When both the ear cups 12, 14 are in the second use position, the individual would put the headphones on their head. As previously described, movement of the ear cup 12 from the first non-use position illustrate in FIG. 7B would force the tactile switch 46 to complete the circuit depicted in FIG. 8, to produce an audio sound directed to each of the ear cups 12, 14.

When the user 70 removes the headphones 10 from their head, the biasing of the spring 72 with the coupling mechanism 18 would automatically return ear cup 12 to the first non-use position in directions shown by arrow 76 in FIG. 7C. The movement of the ear cup 12 from the second use position to the first non-use position would disengage the contact points 39, 47 from one another, thereby opening the tactile switch 46 as shown in FIG. 8 and effectively removing the power source 60 from the circuit 75.

While the preferred embodiments have been shown and described, it will be understood that there is no intent to limit the invention by such disclosure, but rather, is intended to cover all modifications and alternate constructions falling within the spirit and scope of the invention.

1. A pair of headphones including first and second ear cups, a receiver provided in one of the ear cups for receiving a wireless communication signal, and a power source provided in one of the ear cups for powering the operation of the pair of headphones, the pair of headphones comprising:
a switch assembly included in the first ear cup and including a switch provided in a circuit with the power source and the receiver;
the first ear cup including a coupling mechanism allowing rotation of the first ear cup between a first position and a second position;
the switch assembly including a movable post provided in the coupling mechanism, the movable post moving from a first position when the first ear cup is in the first position to a second position engaging the switch when the first ear cup is in the second position;
wherein when the first ear cup is rotated into the second position and the movable post engages the switch, the circuit is completed between the switch, the receiver and the power source to operate the headphones, and further wherein when the first ear cup moves from the second position back to the first position, the circuit is no longer complete, thereby preserving the life of the power source.

2. The pair of headphones according to claim 1, the switch assembly further including a camming piece located in the coupling mechanism provided with a surface which is makes contact with the movable post, a portion of the surface contacting the movable post forces the movable post to move into contact with the switch, when the first ear cup rotates into the second position, the camming piece remaining stationary when the first ear cup rotates between the first and second positions.

3. The pair of headphones according to claim 2, wherein the camming piece is provided with a first section having a first thickness, a second section having a second thickness greater than the first thickness, and a third transition section provided between the first section and the third section, wherein when the first ear cup moves from the first position to the second position, the movable post moves along the surface of the third transition section and into contact with the surface of the second section resulting in the movable post engaging the switch, and wherein when the first ear cup moves from the second position back to the first position, the movable post moves along the surface of the third transition section and into contact with the surface of the first section resulting in the movable post disengaging the switch.

4. The pair of headphones according to claim 1, further including a printed circuit board provided in the first ear cup, the printed circuit board including the circuit provided with the switch, the power source and the receiver.

5. The pair of headphones according to claim 1, wherein the power source is one or more batteries.

6. The pair of headphones according to claim 2, wherein the coupling mechanism includes an upper stationary section and a lower rotating section in which the movable post is provided.

7. The pair of headphones according to claim 1, further including a return device for automatically returning the first ear cup to the first position when the pair of headphones are not in use.

8. The pair of headphones according to claim 7, wherein the return device is a spring biased toward the first position when the first ear cup is rotated into the second position.

9. The pair of headphones according to claim 6, further including a return device for automatically returning the first ear cup to the second position when the pair of headphones are not in use.

10. The pair of headphones according to claim 9, wherein the return device is a spring spanning the upper stationary section and the lower rotating section, the spring is biased toward the first position when the first ear cup is rotated into the second position.
